(19) United States
(12) Patent Application Publication
(10) Pub. No.: US 2022/0258427 A1
(43) Pub. Date: Aug. 18, 2022

(54) MODIFICATION OF A PROPERTY OF FABRICATION COMPONENTS BASED ON A MEASURED COLOR VALUE

(71) Applicant: Hewlett-Packard Development Company, L.P., Spring, TX (US)

(72) Inventor: Arthur H. BARNES, Vancouver, WA (US)

(73) Assignee: Hewlett-Packard Development Company, L.P., Spring, TX (US)

(21) Appl. No.: 17/611,056

(22) PCT Filed: Oct. 11, 2019
(86) PCT No.: PCT/US2019/055954

§ 371 Date: Nov. 12, 2021

(51) Int. Cl. B29C 64/393; B29C 64/153; B33Y 10/00; B33Y 30/00; B33Y 50/02

(52) U.S. Cl. CPC B29C 64/393; B29C 64/153; B33Y 50/02; B33Y 30/00; B33Y 10/00

(57) ABSTRACT

According to examples, an apparatus may include fabrication components and a controller. The fabrication components may fabricate an object having a first color. In some examples, the controller may receive an output of a sensor corresponding to a measured value of the first color on the fabricated object. The controller may determine an adjustment value for a parameter of the fabrication components based on the received output. The adjustment value may be correlated to a level of the received output of the sensor. In some examples, the controller may modify a property of the fabrication components based on the determined adjustment value to cause the fabrication components to fabricate subsequent objects based on the adjustment value.

### BACKGROUND

In three-dimensional (3D) printing, an additive printing process may be used to make 3D solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus for modifying a property of fabrication components to optimize a fusing process for a particular color;

FIG. 2 shows a diagram of components of the example apparatus depicted in FIG. 1;

FIG. 3 shows a flow diagram of an example method for adjusting settings of fabrication components as depicted in FIG. 2 to optimize a fusing process for a particular color; and

FIG. 4 shows a block diagram of an example apparatus that includes a non-transitory computer readable medium on which is stored machine readable instructions for determining an adjustment value to adjust a setting of fabrication components and changing the setting of the fabrication components based on the determined adjustment value to optimize a fusing process for a particular color.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to; “including” means including but not limited to; “based on” means based at least in part on; “and/or” means at least one of the connected things; “cold” and “low temperature” mean below a temperature threshold; a “coloring agent” means a substance that colors a build material; a “detailing agent” means a substance that inhibits or prevents or enhances fusing a build material, for example by modifying the effect of a fusing agent; “deviant” means not acceptable; a “fusing agent” means a substance that causes or helps cause a build material to sinter, melt or otherwise fuse; “hot” and “high temperature” mean above a temperature threshold; a “lamp” means any device that emits light; and “light” means electromagnetic radiation of any wavelength; a “liquid” means a fluid not composed primarily of a gas or gases.

In some additive manufacturing technologies, build material particles, e.g., in powder form, may be distributed in thin layers and selectively joined together to form a solid object. The object may be referred to herein as a part. In some examples, functional agents may be deposited on the powder build material and may fuse the powder build material together using heat. During the fusing process, light absorbing components in the functional agents may absorb light energy to melt, sinter, or otherwise fuse the build material into a layer of the object. The process may be repeated layer by layer to form the object.

The functional agents may include fusing agents, low tint fusing agents, detailing agents, coloring agents, and/or the like. In some examples, different coloring agents may be deposited for different color objects or different colors in an object. In the fusing process, accuracy of the final color of the object may be dependent on a variety of factors including a temperature of the object, a temperature of the powder build material surrounding the object, or the like. In some examples, these factors may be affected by an amount of functional agent deposited on the layer of powder build material. By way of particular example, temperatures of color objects during the fusing process may vary based on differing amounts of infrared (IR) energy absorbed by coloring agents of different colors. As such, the accuracy of the final colors of an object may be difficult to achieve due to such variations.

By way of particular example, the accuracy of the color black may be more difficult to achieve than for other colors because black pigments or dyes used in a black coloring agent may be more absorptive to the IR energy emissions than for other colors. The resulting increase in heat absorbed by the black coloring agent may result in an increased temperature surrounding the object, which in turn may cause unfused build material particles surrounding the object, on which no black fusing agent is applied, to adhere to a surface of the object. The build material particles that adhere to the surface of the object may cause a deviation in the final color, and in some examples may cause a black part to appear grey or white. As such, fabrication of quality black parts may be difficult due to the unwanted adhesion of unfused surrounding powder caused by the relatively high IR absorption by black coloring agents. Although the process causing deviation in object color has been described with respect to black objects, it should be understood that similar processes affect objects of other colors, albeit in different degrees.

Disclosed herein are apparatuses, methods, and computer readable mediums for adjusting a fusing process to optimize for color quality in a fabricated object. The fusing process may be fine-tuned using a test color object fabricated to have a predetermined color. In some examples, fabrication components may fabricate an object having a plurality of colors and a controller may modify a setting of the fabrication components to modify a particular color of the fabricated objects. In some examples, the controller may receive an output of a sensor corresponding to a measured value of one of the plurality of colors on the fabricated object. The controller may then determine an adjustment value for a parameter of the fabrication components based on the received output.

By way of particular example, a sensor may measure a reflectance of a predetermined color on the test color object, and may output a sensor voltage from this measurement. The sensor voltage may be correlated with a lightness number (L*) for the predetermined color, e.g., the color black. In some examples, data included in a lookup table (LUT) may be used to determine fusing component adjustments based on the sensor voltage to optimize the fusing process for an L* value for the predetermined color on subsequent builds. In some examples, the controller may automatically apply the adjustments obtained from the LUT to modify a property of the fabrication components such that the fabrication components may fabricate subsequent objects using, e.g., based on, the adjustments.

Through implementation of the present disclosure, adjustments to properties of the fusing components, e.g., fusing lamp, detailing agent volume, and/or the like, may be achieved to obtain colors that are more accurate. Through use of printed color parts with color patches and low-cost sensors as discussed herein, optimization of the fusing process may be achieved without costly spectrophotometers to fabricate quality color parts. The optimization of the fusing process may result in lower power consumption and fabrication costs by reducing the number of parts fabricated with incorrect colors.

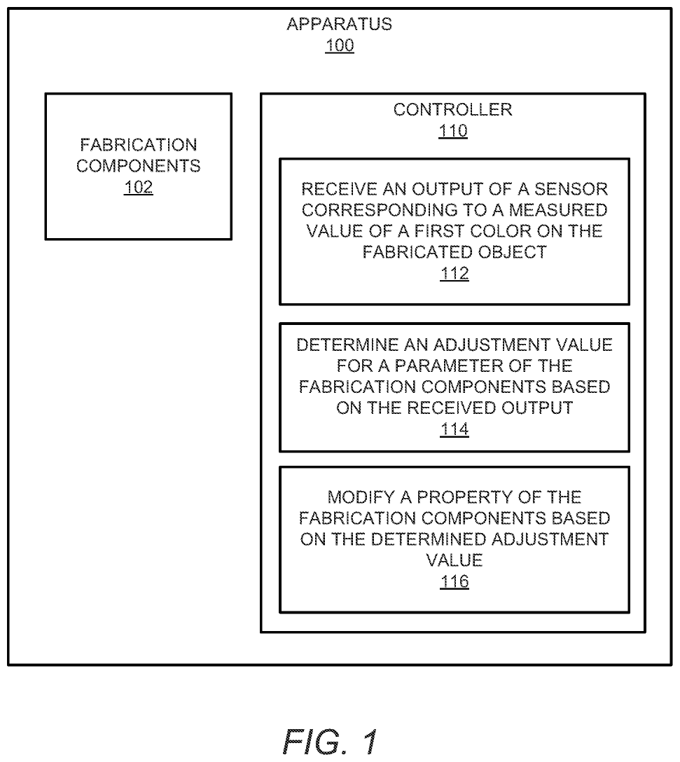

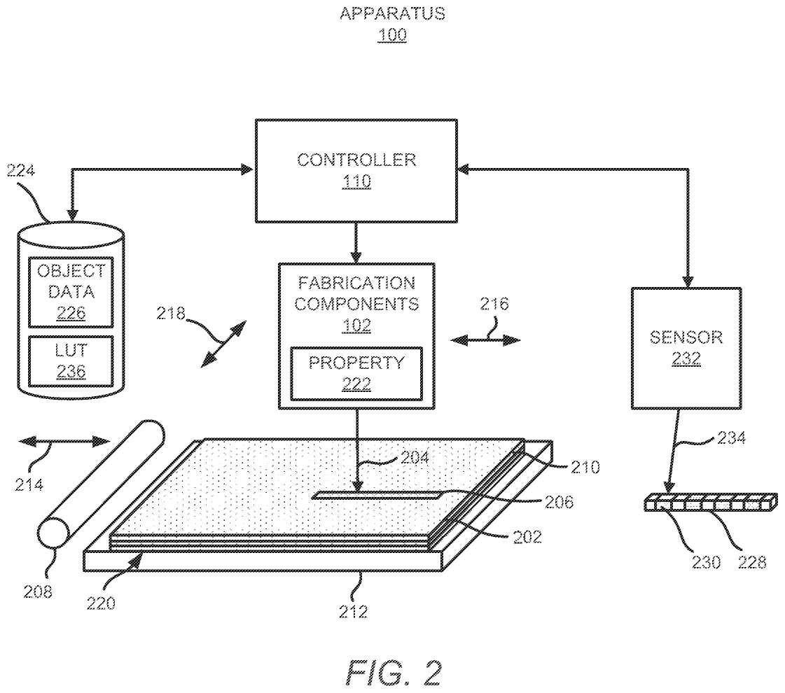

Reference is made to FIGS. 1 and 2. FIG. 1 shows a block diagram of an example apparatus for modifying a property of fabrication components to optimize a fusing process for a particular color. FIG. 2 shows a diagram of components of the example apparatus 100 depicted in FIG. 1. It should be understood that the example apparatus 100 depicted in FIGS. 1 and 2 may include additional features and that some of the features described herein may be removed and/or modified without departing from the scope of the apparatus 100.

The apparatus 100, which may also be termed a 3D fabrication system, a 3D printer, or the like, may be implemented to fabricate 3D objects. As shown in FIG. 1, in some examples, the apparatus 100 may include fabrication components 102 and a controller 110 that may control operations of the fabrication components 102.

As shown in FIG. 2, the fabrication components 102 may be implemented to fabricate 3D objects through selectively solidifying build material particles 202, which may also be termed particles of build material, together. The fabrication components 102 may include, for example, an agent delivery device for depositing fusing agents, a detailing agent, and/or coloring agents, an energy generator including fusing lamps and/or warming lamps, or another appropriate component based on the implementation.

In some examples, the fabrication components 102 may deposit agents 206 and apply energy on the build material particles 202 as indicated by the arrow 204. The fabrication components 102 may use agents 206 that may increase the absorption of energy to selectively fuse the build material particles 202. In some examples, the agents 206 may include fusing and/or binding agents, coloring agents, detailing agents, and/or the like. The fabrication components 102 may use energy, e.g., in the form of light and/or heat, to selectively fuse/bind the build material particles 202. In addition or in other examples, the fabrication components 102 may use agents 206 to selectively solidify the build material particles 202.

According to one example, a suitable agent 206 may be an ink-type formulation including carbon black, such as, for example, the agent 206 formulation commercially known as V1Q60A “HP fusing agent” available from HP Inc. In one example, such an agent 206 may additionally include an infra-red light absorber. In one example such agent 206 may additionally include a near infra-red light absorber. In one example, such an agent 206 may additionally include a UV light absorber. In one example, such an agent 206 may additionally include a visible light absorber. Examples of agents 206 including visible light enhancers are dye based colored ink and pigment based colored ink, such as inks commercially known as CE039A and CE042A available from HP Inc. According to one example, the apparatus 100 may additionally use a detailing agent. According to one example, a suitable detailing agent may be a formulation commercially known as V1Q61A “HP detailing agent” available from HP Inc.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

As shown in FIG. 2, the apparatus 100 may include a spreader 208 (e.g., a roller) that may spread the build material particles 202 into a layer 210, which may also be termed a build layer, e.g., through movement across a platform 212 as indicated by the arrow 214. Instead of or in addition to the spreader 208, the apparatus 100 may include another device, e.g., a sprayer, or the like, that may apply the build material particles 202 into the layer 210.

In some examples, the apparatus 100 may include a carrier (not shown) on which the fabrication components 102 and the spreader 208 may be mounted and scanned across the layer 210. The carrier may be moved bi-directionally as indicated by the arrow 216. The fabrication components 102 may also be scanned in a direction perpendicular to the arrow 216 as indicated by the arrow 218 or in other directions. In addition, or alternatively, the platform 212 on which the layers 210 are deposited may be scanned in directions with respect to the fabrication components 102.

The apparatus 100 may include a build zone 220 (e.g., powder bed) within which the fabrication components 102 may solidify the build material particles 202 in the layer 210. The agent 206 may be deposited in regions at which portions of a 3D object are to be fabricated in multiple layers 210 of the build material particles 202.

The fabrication components 102 may be scanned across the build zone 220 (as depicted by the arrow 216) to selectively deliver the agent 206 onto the build material particles 202 on the layer 210. In some examples, the agent 206 may enhance absorption of the energy to cause the build material particles 202 upon which the agent 206 has been deposited to melt. The agent 206 may be applied to the build material particles 202 prior to application of energy onto the build material particles 202.

Once the agent 206 has been deposited on specific regions of the build material particles 202 on layer 210, the energy generator may emit energy at specific energy levels to cause reactions in the agent 206. In any regard, the particles 202 may equivalently be termed fused build material particles, solidified build material, bound build material particles, or the like. The solidified build material particles 202 may be a part of a 3D object, and the 3D object may be built through selective solidifying of the build material particles 202 in multiple layers 210 of the build material particles 202.

In some examples, the fabrication components 102 may supply coloring agents during the fabrication process to fabricate color objects. The fabrication components 102 may supply different combinations of agents 206, including coloring agents, fusing agents, detailing agents, and/or other appropriate types of functional agents during the fusing process. By way of particular example, the fabrication components 102 may deposit different combinations of the agents 206 in different regions that form the object, and interactions between the different combinations of agents 206 may cause different amounts of energy to be absorbed in each of the regions. In order to cause a surface of the object to form, a thermal gradient may be formed between an inner region, which may have a relatively higher temperature, to an outer region of the object, which may have a relatively lower temperature. In color objects, the fabrication process may be sensitive to variations in temperatures at regions around the surface of the object for fabricating quality color parts, due in part to presence of the coloring agents surrounding the object.

By way of particular example, the different regions of the object may be defined to include a central region, which may be termed a core. The core may be surrounded by different successive regions, including a mantle, a crust, a surface, and an atmosphere. The central region may contain only fusing agent 206 to absorb the largest amount of energy among the different regions, and may reach a predetermined temperature (e.g., 210-220° C.), above a melt temperature of the build material particles 202 during the fusing process. Heating the build material particles 202 to the predetermined temperature may enable fusing of the build material particles 202.

Beyond the core, the different successive regions may have agents 206 that have different combinations of fusing agents and coloring agents. The different combinations of fusing agents and coloring agents (e.g., color pigments or dyes) may cause the agents 206 to absorb different amounts of IR energy, thereby resulting in a thermal gradient in the build material particles 202 from the central region to the outer regions. By way of particular example, the region outside the central region (e.g., the mantle) may include the fusing agent and/or a low tint fusing agent (LTFA) that may enable a transition for matching a lightness of a target color. The next region (e.g., the crust) may include a combination of coloring agents and fusing agents that may enable a color depth nearing that of the target color. The next region (e.g., the surface) may also include a combination of coloring agents and fusing agents that may allow for modification of the color to achieve the target color. The next region (e.g., the atmosphere), which may be in an unfused state, may include coloring agents. The atmosphere may be disposed between the fused object and surrounding unfused build material particles 202. The temperatures in these regions may be controlled to cause the build material particles 202 to fuse having the target color.

In some examples, because the coloring agents present in the atmosphere region of the object may absorb IR energy, a temperature within the atmosphere region may rise above a target or threshold temperature. As such, the thermal transition within the object may be made more difficult and sensitive to process variations, and thus deviations in the final color of the object may result.

By way of particular example, in an ideal case in which a final color of the object matches a target color, a temperature of the build material particles 202 treated with the agents 206 may drop below the melt temperature in the atmosphere to ensure that the build material particles 202 are well fused and no unfused white powder is adhered to a surface of the object. In some examples, when the temperature in the atmosphere region is greater than a target threshold, residual build material particles 202 beyond the atmosphere region may bind to the surface of the object, which may cause variation in the final color or deviant colors.

The temperature of the build material particles 202 in the atmosphere region may rise above the target threshold due to absorption of IR energy by the coloring agents in the atmosphere region. The coloring agents for certain colors may absorb a greater amount of IR energy than other colors. By way of particular example, a coloring agent for black may include black pigment or dye that may absorb more IR energy than, for example, cyan, magenta, or yellow. As such, black pigments or dyes may cause increased temperatures in the atmosphere region, which in turn may cause increased process sensitivity resulting in unwanted deviations in the final color of the object. In some examples, modification of certain settings of the fabrication components 102 may allow for adjustment in the temperature in the atmosphere region, which may result in improved color quality of the object.

In some examples, the fabrication components 102 may include a property 222, which may also be termed a setting, which may control an operation of the fabrication components 102 during the fusing process. By way of particular example, the property 222 may modify the types and/or amounts of agents 206 deposited onto each of the layers 210 by the fabrication components 102. The property 222 may also control an amount of energy supplied by the fusing/warming lamps, for example, based on a target temperature in different regions of the object (e.g., at the surface or atmosphere region of the object) or at the unfused build material particles 202 surrounding the object.

In some examples, the apparatus 100 may include a controller 110 that may modify values of the property 222. The controller 110 may be a semiconductor-based microprocessor, a central processing unit (CPU), an application specific integrated circuit (ASIC), a field-programmable gate array (FPGA), and/or other suitable hardware device.

In some examples, the apparatus 100 may also include a data store 224. The data store 224 may be an electronic, magnetic, optical, or other physical storage device that contains or stores executable instructions. The data store 224 may be, for example, Random Access memory (RAM), an Electrically Erasable Programmable Read-Only Memory (EEPROM), a storage device, an optical disc, and the like. The data store 224, which may also be referred to as a memory or a computer readable storage medium, may be a non-transitory machine-readable storage medium, where the term “non-transitory” does not encompass transitory propagating signals.

The controller 110 may access object data 226 from the data store 224 for fabricating an object 228. The object 228 may be fabricated based on the processes previously described with respect to the fabrication components 102. In some examples, the object 228 may be a test color object and may include a plurality of colors 230. The object data 226 may include information regarding predetermined colors to be fabricated into the object 228. By way of particular example, the object 228 may be a color stick, and the plurality of colors 230 may be formed as color patches or color tiles on the color stick. It should be understood that the object 228 may include any suitable type of object and may include a color or a plurality of colors.

In some examples, the data store 224 may have stored thereon machine-readable instructions 112-116 (which may also be termed computer readable instructions) that the controller 110 may execute. The controller 110 may fetch, decode, and execute the machine-readable instructions 112 to receive an output of a sensor 232 corresponding to a measured value of a first color (e.g., one of a plurality of colors 230) on the object 228.

As illustrated in FIG. 2, the sensor 232 may sense a property of a particular color 230 on the object 228 as depicted by the arrow 234. The color 230 may be a predetermined color having known characteristics that the sensor 232 may measure. By way of particular example, the sensor 232 may sense a reflectance of the color 230 and may output a value corresponding to the sensed reflectance. In some examples, the output may be a voltage, a current, or another appropriate type of output from the sensor 232.

The output from the sensor 232 may be correlated to a property of the color 230. By way of particular example, the output of the sensor 232 may be a voltage level that may be correlated to a sensed property of the color 230. In some examples, the sensed property may be represented by a CIELAB color space value. The CIELAB color space expresses color in three values: L* for lightness, a* for the red-green component, and b* for the blue-yellow component. By way of particular example, the output voltage level of the sensor may be correlated to the L* value that represents a relative lightness or darkness of the sensed color 230. In some examples, a zero L* value may mean all light is absorbed (perfect black) while a 100 L* value may mean all light is reflective (perfect white).

In some examples, predetermined voltage levels output from the sensor 232 may be correlated to a particular L* value for a particular color 230. The correlation between the sensor output and the L* values for the particular color 230 may be determined based on experiments, measurements, previous knowledge, available data resources, or the like. In some examples, the correlation between the sensor output voltage levels and L* values may be determined using a spectrophotometer, or another appropriate type of measuring device. By way of particular example, the sensor output voltage levels may be correlated to L* values for black, and a particular sensor output voltage level may indicate a quality, e.g., a lightness, of black on the sensed object 228.

In some examples, the controller 110 may fetch, decode, and execute the machine-readable instructions 114 to determine an adjustment value for a parameter of the fabrication components 102 based on the received output of the sensor 232. The controller 110 may then retrieve the adjustment value from a LUT 236 based on the received output.

In some examples, the LUT 236 may be stored on the data store 224 and may include adjustment values for parameters of the fusing process. For purposes of illustration, Table 1 shows an example LUT 236 for a black tile. As shown in Table 1, the LUT 236 may include various sensor voltage levels for the color black correlated to various adjustment values for different parameters of the fusing process. The parameters may include a build material target temperature, a fabricated object target temperature, an amount of functional agent load, and/or another appropriate type of parameter of the fabrication components 102 that may affect a temperature in the atmosphere of the object during the fusing process. The build material target temperature may be an adjustment to a target temperature of the unfused build material particles 202 outside of the atmosphere region of the object. The fabricated object target temperature may be an adjustment to a target temperature of the build material particles 202 on a surface of the object. Furthermore, the amount of functional agent load may be an adjustment to an amount of agent 206, such as a detailing agent, which may be deposited during the fusing process. Each value of the sensor output may be correlated to a particular adjustment value for each of the properties of the fusing process.

TABLE 1

| Sensor Voltage | Build Material | | Fabricated Object | | Functional |
|---|---|---|---|---|---|
| Level | Target Temp | | Target Temp | | Agent Load |
| 0 | No Adjustment | | No Adjustment | | No Adjustment |
| 0.05 | No Adjustment | | No Adjustment | | No Adjustment |
| 0.1 | No Adjustment | | No Adjustment | | No Adjustment |
| 0.15 | No Adjustment | | No Adjustment | | No Adjustment |
| 0.2 | No Adjustment | | No Adjustment | | No Adjustment |
| 0.25 | No Adjustment | | No Adjustment | | No Adjustment |
| 0.3 | No Adjustment | | No Adjustment | | No Adjustment |
| 0.35 | −1 | C. | −1 | C. | No Adjustment |
| 0.4 | −1 | C. | −1 | C. | No Adjustment |
| 0.45 | −1 | C. | −1 | C. | No Adjustment |
| 0.5 | −1 | C. | −1 | C. | No Adjustment |
| 0.55 | −1 | C. | −1 | C. | No Adjustment |
| 0.6 | −1.5 | C. | −1.5 | C. | No Adjustment |
| 0.65 | −1.5 | C. | −1.5 | C. | No Adjustment |
| 0.7 | −1.5 | C. | −1.5 | C. | No Adjustment |
| 0.75 | −1.5 | C. | −1.5 | C. | No Adjustment |
| 0.8 | −2 | C. | −2 | C. | No Adjustment |
| 0.85 | −2 | C. | −2 | C. | No Adjustment |
| 0.9 | −2 | C. | −2 | C. | No Adjustment |
| 0.95 | −2 | C. | −2 | C. | +1 |
| 1 | −2 | C. | −2 | C. | +1 |
| >1 | −3 | C. | −3 | C. | +2 |

By way of particular example, a target L* value for a black tile and on fabricated objects may be 40 L*, which may be correlated to a sensor output voltage of 0.3V. The target L* value may be set based on an acceptable level of quality of the color black. For purposes of illustration, let us assume that a sensor output voltage of 0.5V is received from the sensor 232. The sensor output voltage of 0.5V may be correlated to an L* value of 52 for black, which may represent a color of black that appears grey or whitish (e.g., lighter than a target lightness). As previously discussed, the deviant color may be caused by increased heat in the atmosphere of the object, which may cause white unfused build material particles 202 to bind to a surface of the object. Referring to Table 1, sensor voltage level of 0.5V may be correlated to an adjustment in the powder target temperature of −1° C., an adjustment in the part target temperature of −1° C., and no adjustment in the amount of functional agent deposited by the fabrication components 102. These adjustments to the parameters of the fabrication components 102 may decrease the temperature in the atmosphere during subsequent fusing processes, which may reduce an amount of unfused build material particles 202 that may bind to the surface of the object.

The controller 110 may fetch, decode, and execute the machine-readable instructions 116 to modify a property 222 of the fabrication components 102 based on the determined adjustment value to cause the fabrication components 102 to fabricate subsequent objects based on the adjustment value. In some examples, the controller 110 may automatically apply the adjustment values obtained from the LUT 236 to the property 222 of the fabrication components 102. The property 222 may be associated with the parameters of the fabrication components 102 as previously described with respect to Table 1. In some examples, the property 222 may modify an amount of energy applied by the energy generator and/or an amount of agent 206 deposited by the agent delivery device to achieve a modified target temperature during the fusing process.

In some examples, the sensor 232 may be integrated into the apparatus 100 and connected to the controller 110. The controller 110 may cause the sensor 232 to sense a predetermined color 230 on the object 228. The controller 110 may then receive an output from the sensor 232 corresponding to the measured color 230. In some examples, the controller 110 may cause the sensor 232 to sense a first layer 210 of an object during the fusing process, and may modify the property 222 of the fabrication components 102 for subsequent layers 210 of the object 228.

In some examples, the sensor 232 may be disposed physically separately from the apparatus 100. In this case, the sensor 232 may be communicatively coupled to the controller 110. In some examples, the controller 110 may fabricate the object 228 using the object data 226 obtained from the data store 224. Once fabrication of the object 228 has completed, a user may remove the object 228 from the build platform 212 and place the object 228 with respect to the sensor 232 for the sensor 232 to sense a particular color on the object 228. In some examples, a surface of the object 228 may be cleaned or post-processed prior to being placed with respect to the sensor 232. The output values for the sensed color may be transmitted from the sensor 232 to the controller 110 for modifying the property 222 of the fabrication components 102. In some examples, the controller 110 may automatically update the property 222 of the fabrication components 102 based on the output from the sensor 232 to optimize the fusing process for the sensed color during subsequent builds.

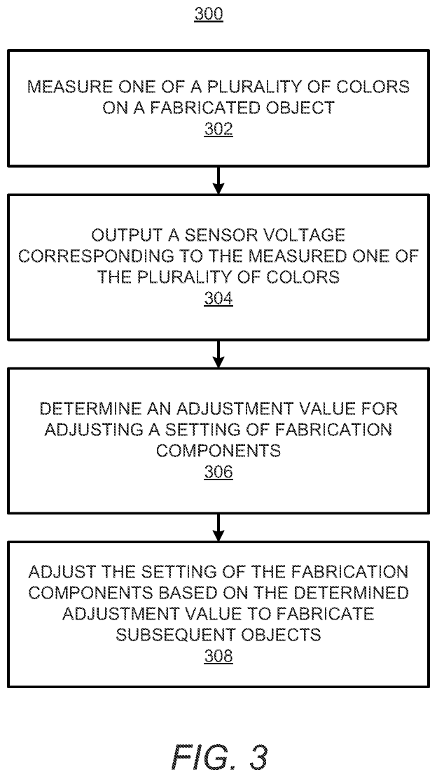

Turning now to FIG. 3, there is shown a flow diagram of an example method 300 for adjusting settings of fabrication components 102 as depicted in FIG. 2 to optimize a fusing process for a particular color. It should be understood that the method 300 depicted in FIG. 3 may include additional operations and that some of the operations described therein may be removed and/or modified without departing from the scope of the method 300. The description of the method 300 is also made with reference to the features depicted in FIGS. 1-2 for purposes of illustration. Particularly, the controller 110 of the apparatus 100 may execute some or all of the operations included in the method 300.

With reference first to FIG. 3, at block 302, the sensor 232 may measure one of a plurality of colors 230 on a fabricated object 228. In one example, the sensor 232 may measure a reflectance of one of the plurality of colors 230. At block 304, the sensor 232 may output a sensor voltage corresponding to the measured one of the plurality of colors 230. In some examples, the sensor voltage may be correlated to an L* value for the measured color 230.

At block 306, the controller 110 may determine an adjustment value for adjusting a setting of the fabrication components 102 based on the outputted sensor voltage. In one example, the controller 110 may obtain the adjustment value from a LUT 236, which may be stored on a data store 224. The LUT 236 may include adjustment values associated with various parameters of the fabrication components 102. In some examples, the LUT 236 may include adjustment values associated with a build material target temperature, an object target temperature, and/or an amount of detailing agent to be deposited during the fusing process. At block 308, the controller 110 may adjust a setting of the fabrication components 102 to fabricate subsequent objects based on, e.g., using, the adjusted setting. In some examples, the setting of the fabrication components 102 may be a property 222 of the fabrication components 102 as previously described with respect to FIG. 2. The adjustment values may be associated with modifying the setting of the fabrication component 102 to achieve a target L* value for the measured color 230 in subsequent fabricated objects.

In some examples, the sensor 232 may be integrated into the apparatus 100 and the controller 110 of the apparatus 100 may control the sensor 232. In this case, the controller 110 may control operations of the sensor 232 and may cause the sensor 232 to measure the color 230 on the fabricated object 228. In some examples, the sensor 232 may be separate from the apparatus 100. In this case, the sensor 232 may be communicatively coupled to the controller 110 of the apparatus 100 to transfer the sensor output to the controller 110. In some examples, the sensor output may be manually entered into the controller 110.

Some or all of the operations set forth in the method 300 may be contained as utilities, programs, or subprograms, in any desired computer accessible medium. In addition, the method 300 may be embodied by computer programs, which may exist in a variety of forms. For example, the method 300 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

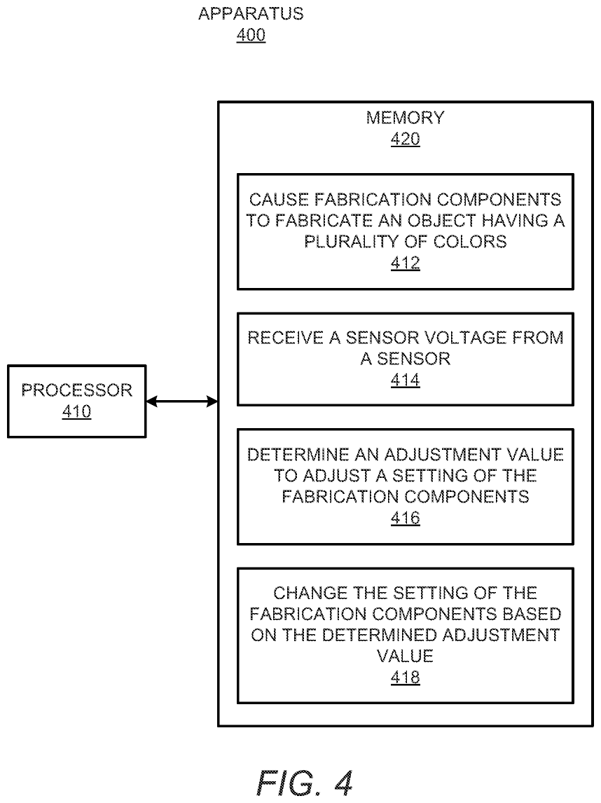

Turning now to FIG. 4, there is shown a block diagram of an example apparatus 400 that includes a processor 410 and a memory 420 on which is stored machine readable instructions 412-418 for determining an adjustment value to adjust a setting of fabrication components 102 and changing the setting of the fabrication components 102 based on the determined adjustment value to optimize a fusing process for a particular color. The descriptions of the apparatus 400 are made with reference to the features depicted in FIGS. 1-2 for purposes of illustration. Particularly, the controller 110 of the apparatus 100 may execute some or all of the machine readable instructions 412-418.

Particularly, the processor 410 may execute the instructions 412 to cause fabrication components 102 to fabricate an object 228 having a plurality of colors 230. The processor 410 may execute the instructions 414 to receive a sensor voltage from a sensor 232. In some examples, the sensor voltage received from the sensor 232 may correspond to a reflectance of one of the plurality of colors 230 on the fabricated object 228.

The processor 410 may execute the instructions 416 to determine an adjustment value to adjust a setting of the fabrication components 102. The setting may be the same as the property 222 previously described with respect to FIG. 2. In some examples, the adjustment value may be determined using data included in a LUT 236 stored on a data store 224. The LUT 236 may have a plurality of adjustment values for parameters of the fusing process correlated to a particular output voltage of the sensor 232.

The processor 410 may execute the instructions 418 to change the setting of the fabrication components 102 based on the determined adjustment value to cause the fabrication component 102 to fabricate subsequent objects based on the changed setting. In some examples, the adjustment values may modify the fusing process to obtain a target L* number for a selected color on subsequent builds. In some examples, the object 228 having the plurality of colors 230 may have a plurality of color patches. In some examples, the plurality of color patches may include a black color patch, through use of which the fusing process may be optimized for color.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A apparatus comprising:
fabrication components to fabricate an object having a first color; and
a controller to:
receive an output of a sensor corresponding to a measured value of the first color on the fabricated object;
determine an adjustment value for a parameter of the fabrication components based on the received output, the adjustment value being correlated to a level of the received output; and
modify a property of the fabrication components based on the determined adjustment value to cause the fabrication components to fabricate subsequent objects based on the adjustment value.

2. The apparatus of claim 1, wherein the controller is to control the fabrication components to fabricate the object to have a plurality of color patches.

3. The apparatus of claim 1, wherein the controller is to determine the adjustment value for the parameter of the fabrication components as a predefined adjustment value associated with a build material target temperature, a fabricated object target temperature, or a quantity of detailing agent during fabrication.

4. The apparatus of claim 3, wherein the controller is to determine the predefined adjustment value as a predetermined amount of modification in the build material target temperature, the fabricated object target temperature, or the quantity of detailing agent that corresponds to an amount of deviation in the first color on the fabricated object relative to a threshold value, the amount of deviation being based on the received output of the sensor.

5. The apparatus of claim 1, further comprising a sensor to measure the value of the first color, wherein the output of the sensor comprises a voltage level that correlates to a lightness value (L*) for the first color on the fabricated object.

6. The apparatus of claim 1, wherein the controller is to retrieve the adjustment value from a lookup table (LUT) based on the received output of the sensor.

7. The apparatus of claim 6, wherein the LUT includes a plurality of sensor voltages that are correlated to respective L* measurements for the first color and corresponding adjustment values associated with the plurality of sensor voltages.

8. The apparatus of claim 6, wherein the first color is black, and a plurality of sensor voltages in the LUT correspond to a plurality of adjustment values tuned to a threshold L* value for the color black.

9. A method comprising:
measuring, by a sensor, one of a plurality of colors on a fabricated object;
outputting, by the sensor, a sensor voltage corresponding to the measured one of the plurality of colors, the sensor voltage being correlated to a lightness (L*) value of the measured one of the plurality of colors;
determining, by a controller, an adjustment value for adjusting a setting of fabrication components based on the outputted sensor voltage; and
adjusting, by the controller, the setting of the fabrication components based on the determined adjustment value to fabricate subsequent objects using the adjusted setting.

10. The method of claim 9, further comprising:
retrieving the adjustment value from a memory based on the sensor voltage.

11. The method of claim 9, further comprising:
changing a build material target temperature, a fabricated object target temperature, or a quantity of a detailing agent for the fabrication components based on the determined adjustment value for adjusting the setting of the fabrication components.

12. The method of claim 9, wherein measuring further comprises measuring, by the sensor, a reflectance of the one of the plurality of colors on the fabricated object.

13. The method of claim 9, further comprising:
fabricating, by the fabrication components, the object having the plurality of colors;
adjusting the setting of the fabrication components to optimize for black L* based on a black patch on the fabricated object; and
fabricating, by the fabrication components, objects on subsequent builds based on the adjusted setting of the fabrication components.

14. An apparatus comprising:
a processor; and
a memory on which are stored machine readable instructions that when executed by the processor, cause the processor to:
cause fabrication components to fabricate an object having a plurality of colors;
receive a sensor voltage from a sensor, the sensor voltage corresponding to a reflectance of one of the plurality of colors on the fabricated object;
determine an adjustment value to adjust a setting of the fabrication components, the adjustment value being based on the received sensor voltage; and
change the setting of the fabrication components based on the determined adjustment value to cause the fabrication components to fabricate subsequent objects based on the changed setting.

15. The apparatus of claim 14, wherein the instructions are to cause the processor to fabricate the object having the plurality of colors to have a plurality of color patches, the plurality of color patches including a black color patch.
